(19) United States
(12) Patent Application Publication
(10) Pub. No.: US 2025/0370536 A1
(43) Pub. Date: Dec. 4, 2025

(54) Controlling an Electronic Device Using Gaze and Gesture Inputs

(71) Applicant: Apple Inc., Cupertino, CA (US)

(72) Inventors: Brandon K. Schmuck, San Mateo, CA (US); Benjamin S. Phipps, San Francisco, CA (US); David Grayson Smith, San Francisco, CA (US)

(21) Appl. No.: 19/195,220

(22) Filed: Apr. 30, 2025

Related U.S. Application Data
(60) Provisional application No. 63/654,291, filed on May 31, 2024.

(51) Int. Cl. G06F 3/01; G06T 7/70; H04N 21/4223

(52) U.S. Cl. CPC G06F 3/013; G06F 3/012; G06F 3/017; G06T 7/70; H04N 21/4223

(57) ABSTRACT

An electronic device may be used to control an external electronic device. Camera images may be used to determine a location of a display associated with the external electronic device relative to the electronic device. Camera images may also be used to identify a gaze direction of the user and gesture inputs from a user. The gaze direction and the location of the display relative to the electronic device may be used to determine a location on the display that is targeted by the user's gaze. The electronic device may transmit the identified gesture input and/or the determined location on the display that is targeted by the user's gaze to the external electronic device to control the external electronic device.

This application claims the benefit of U.S. provisional patent application No. 63/654,291, filed May 31, 2024, which is hereby incorporated by reference herein in its entirety.

### BACKGROUND

This relates generally to electronic devices, and, more particularly, to electronic devices with displays.

Some electronic devices with displays such as televisions may have dedicated remote controls to allow control of the electronic device. Controlling electronic devices with remote controls may be more difficult than desired.

### SUMMARY

An electronic device may include one or more sensors, communication circuitry, one or more processors, and memory storing instructions configured to be executed by the one or more processors, the instructions for: obtaining, via a first subset of the one or more sensors, an image that includes a display, obtaining, via a second subset of the one or more sensors, a gaze input, determining, using at least the gaze input and the image, a location on the display corresponding to the gaze input, obtaining, via the second subset of the one or more sensors, a gesture input, and transmitting information associated with the location on the display and the gesture input to an external electronic device using the communication circuitry.

### BRIEF DESCRIPTION OF THE DRAWINGS

FIG. 1 is a schematic diagram of an illustrative electronic device in accordance with some embodiments.

FIG. 2A is a perspective view of an illustrative cellular telephone with a display and a camera in accordance with some embodiments.

FIG. 2B is a perspective view of an illustrative tablet computer with a display and a camera in accordance with some embodiments.

FIG. 2C is a perspective view of an illustrative laptop computer with a display and a camera in accordance with some embodiments.

FIG. 3 is a view of an illustrative system that includes an electronic device and a display with content controlled by gaze and gesture input in accordance with some embodiments.

FIG. 4 is a side view of an illustrative system that includes a display and an electronic device that captures images of the display and a user in accordance with some embodiments.

FIG. 5A is a view of an illustrative display that presents an optical symbol for optical pairing with an electronic device in accordance with some embodiments.

FIG. 5B is a view of an illustrative display with a first user interface element that is targeted by gaze input in accordance with some embodiments.

FIG. 5C is a view of an illustrative display with a second user interface element that is targeted by gaze input in accordance with some embodiments.

FIG. 5D is a view of an illustrative display with a second user interface element that is selected by gesture input in accordance with some embodiments.

FIG. 6 is a flowchart of an illustrative method for operating an electronic device that uses gaze and gesture input sensed at the electronic device to control an external electronic device in accordance with some embodiments.

### DETAILED DESCRIPTION

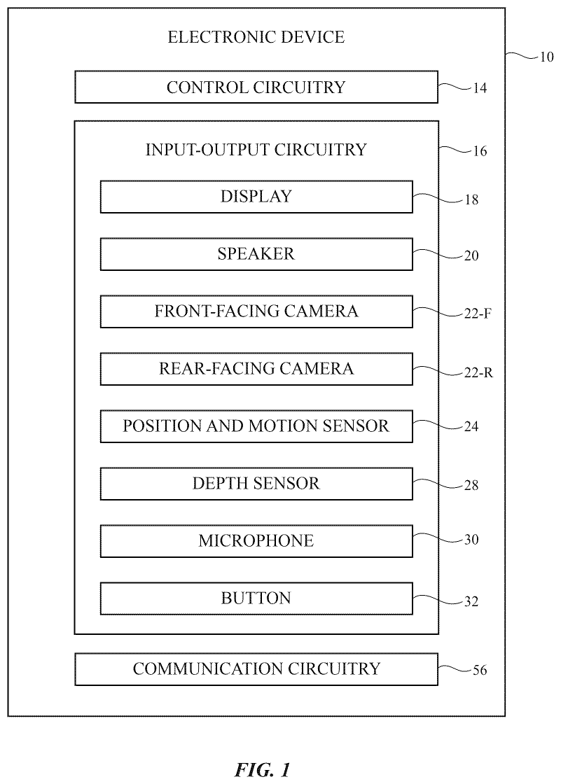

A schematic diagram of an illustrative electronic device is shown in FIG. 1. As shown in FIG. 1, electronic device 10 may have control circuitry 14. Electronic device 10 may be a head-mounted device, cellular telephone, laptop computer, speaker, computer monitor, electronic watch, tablet computer, etc.

Control circuitry 14 may be configured to perform operations in electronic device 10 using hardware (e.g., dedicated hardware or circuitry), firmware and/or software. Software code for performing operations in electronic device 10 and other data is stored on non-transitory computer readable storage media (e.g., tangible computer readable storage media) in control circuitry 14. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid-state drives), one or more removable flash drives or other removable media, or the like. Software stored on the non-transitory computer readable storage media may be executed on the processing circuitry of control circuitry 14. The processing circuitry may include application-specific integrated circuits with processing circuitry, one or more microprocessors, digital signal processors, graphics processing units, a central processing unit (CPU) or other processing circuitry.

Electronic device 10 may include input-output circuitry 16. Input-output circuitry 16 may be used to allow a user to provide electronic device 10 with user input. Input-output circuitry 16 may also be used to gather information on the environment in which electronic device 10 is operating. Output components in circuitry 16 may allow electronic device 10 to provide a user with output.

As shown in FIG. 1, input-output circuitry 16 may include a display such as display 18. Display 18 may be used to display images for a user of electronic device 10. Display 18 may be an organic light-emitting diode display or other display based on an array of light-emitting diodes, a liquid crystal display, a liquid-crystal-on-silicon display, a projector or display based on projecting light beams on a surface directly or indirectly through specialized optics (e.g., digital micromirror devices), an electrophoretic display, a plasma display, an electrowetting display, or any other desired display.

Display 18 may optionally be transparent or translucent so that a user may observe physical objects through the display while computer-generated content is overlaid on top of the physical objects by presenting computer-generated images on the display. A transparent or translucent display may be formed from a transparent or translucent pixel array (e.g., a transparent organic light-emitting diode display panel) or may be formed by a display device that provides images to a user through a transparent structure such as a beam splitter, holographic coupler, or other optical coupler (e.g., a display device such as a liquid crystal on silicon display). Alternatively, display 18 may be an opaque display that blocks light from physical objects when a user operates electronic device 10.

Input-output circuitry 16 may include various other input-output devices. For example, input-output circuitry 16 may include one or more speakers 20 that are configured to play audio and one or more microphones 30 that are configured to capture audio data from the user and/or from the physical environment around the user.

Input-output circuitry 16 may include one or more cameras 22 such as front-facing camera 22-F and rear-facing camera 22-R. The front-facing camera 22-F may face the same direction as display 18 such that the front-facing camera captures images of the user while the user views the display. The rear-facing camera 22-R may face the opposite direction as display such that the rear-facing camera captures images of the physical environment around the electronic device while the user views the display. Cameras 22 may capture visible light images, infrared images, or images of any other desired type. The cameras may be stereo cameras if desired.

As shown in FIG. 1, input-output circuitry 16 may include position and motion sensors 24 (e.g., compasses, gyroscopes, accelerometers, and/or other devices for monitoring the location, orientation, and movement of electronic device 10, satellite navigation system circuitry such as Global Positioning System circuitry for monitoring user location, etc.). Using sensors 24, for example, control circuitry 14 can monitor the current direction in which electronic device 10 is oriented relative to the surrounding environment.

Input-output circuitry 16 may include one or more depth sensors 28. Each depth sensor may be a pixelated depth sensor (e.g., that is configured to measure multiple depths across the physical environment) or a point sensor (that is configured to measure a single depth in the physical environment). Each depth sensor (whether a pixelated depth sensor or a point sensor) may use phase detection (e.g., phase detection autofocus pixel(s)) or light detection and ranging (LIDAR) to measure depth. Camera images (e.g., from one of cameras 22) may also be used for monocular and/or stereo depth estimation. Any combination of depth sensors may be used to determine the depth of physical objects in the physical environment.

Input-output circuitry 16 may include a button 32. The button may include a mechanical switch that detects a user press during operation of the electronic device. Alternatively, button 32 may be a virtual button that detects a user press using touch sensing.

Input-output circuitry 16 may also include other sensors and input-output components if desired (e.g., ambient light sensors, force sensors, temperature sensors, touch sensors, capacitive proximity sensors, light-based proximity sensors, other proximity sensors, strain gauges, gas sensors, pressure sensors, moisture sensors, magnetic sensors, audio components, haptic output devices such as actuators and/or vibration motors, light-emitting diodes, other light sources, etc.).

Electronic device 10 may also include communication circuitry 56 to allow the electronic device to communicate with external equipment (e.g., a tethered computer, a portable device, one or more external servers, or other electrical equipment). Communication circuitry 56 may be used for both wired and wireless communication with external equipment.

Communication circuitry 56 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

The radio-frequency transceiver circuitry in wireless communications circuitry 56 may handle wireless local area network (WLAN) communications bands such as the 2.4 GHz and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHz), a cellular low-midband (LMB) (e.g., 1400 to 1550 MHZ), a cellular midband (MB) (e.g., from 1700 to 2200 MHz), a cellular high band (HB) (e.g., from 2300 to 2700 MHZ), a cellular ultra-high band (UHB) (e.g., from 3300 to 5000 MHz, or other cellular communications bands between about 600 MHz and about 5000 MHz (e.g., 3G bands, 4G LTE bands, 5G New Radio Frequency Range 1 (FR1) bands below 10 GHz, etc.), a near-field communications (NFC) band (e.g., at 13.56 MHz), satellite navigations bands (e.g., an L1 global positioning system (GPS) band at 1575 MHz, an L5 GPS band at 1176 MHz, a Global Navigation Satellite System (GLONASS) band, a BeiDou Navigation Satellite System (BDS) band, etc.), ultra-wideband (UWB) communications band(s) supported by the IEEE 802.15.4 protocol and/or other UWB communications protocols (e.g., a first UWB communications band at 6.5 GHz and/or a second UWB communications band at 8.0 GHz), and/or any other desired communications bands.

The radio-frequency transceiver circuitry may include millimeter/centimeter wave transceiver circuitry that supports communications at frequencies between about 10 GHz and 300 GHz. For example, the millimeter/centimeter wave transceiver circuitry may support communications in Extremely High Frequency (EHF) or millimeter wave communications bands between about 30 GHz and 300 GHz and/or in centimeter wave communications bands between about 10 GHz and 30 GHz (sometimes referred to as Super High Frequency (SHF) bands). As examples, the millimeter/centimeter wave transceiver circuitry may support communications in an IEEE K communications band between about 18 GHz and 27 GHz, a Kₐ communications band between about 26.5 GHz and 40 GHz, a Kᵤ communications band between about 12 GHz and 18 GHz, a V communications band between about 40 GHz and 75 GHz, a W communications band between about 75 GHz and 110 GHz, or any other desired frequency band between approximately 10 GHz and 300 GHz. If desired, the millimeter/centimeter wave transceiver circuitry may support IEEE 802.11ad communications at 60 GHz (e.g., WiGig or 60 GHz Wi-Fi bands around 57-61 GHz), and/or 5^{th} generation mobile networks or 5^{th} generation wireless systems (5G) New Radio (NR) Frequency Range 2 (FR2) communications bands between about 24 GHz and 90 GHz.

Antennas in wireless communications circuitry 56 may include antennas with resonating elements that are formed from loop antenna structures, patch antenna structures, inverted-F antenna structures, slot antenna structures, planar inverted-F antenna structures, helical antenna structures, dipole antenna structures, monopole antenna structures, hybrids of these designs, etc. Different types of antennas may be used for different bands and combinations of bands. For example, one type of antenna may be used in forming a local wireless link and another type of antenna may be used in forming a remote wireless link antenna.

Electronic device 10 may be paired with one or more additional electronic devices. In other words, a wireless link may be established between electronic device 10 and an additional electronic device to allow fast and efficient communication between device 10 and the additional electronic device.

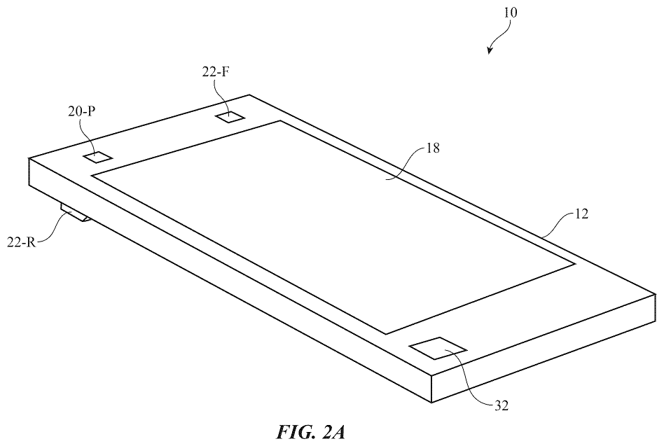

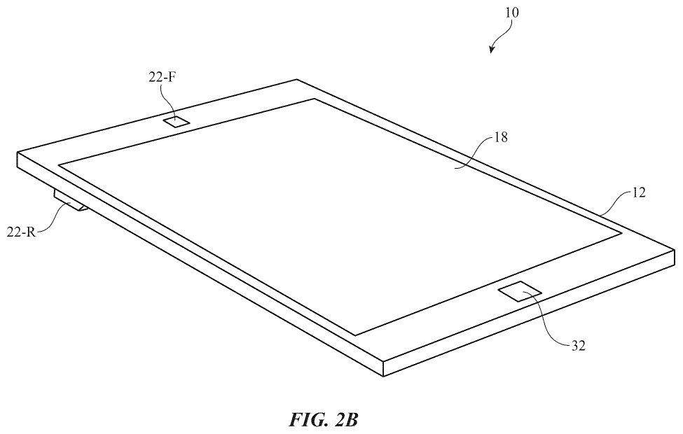

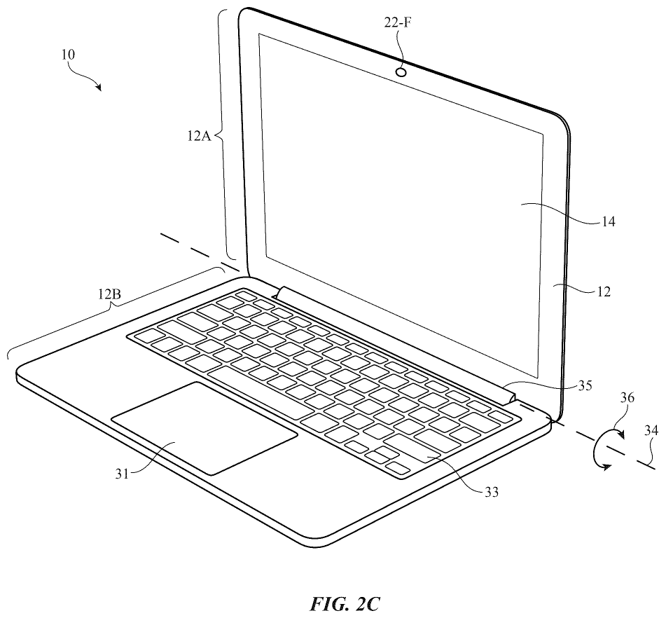

Illustrative electronic devices that may be provided with displays and cameras are shown in FIGS. 2A-2C.

FIG. 2A shows an illustrative configuration for electronic device 10 based on a handheld device such as a cellular telephone, music player, gaming device, navigation unit, or other compact device. In this type of configuration for device 10, device 10 has a housing 12 has opposing front and rear surfaces. Display 18 is mounted on a front face of housing 12. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Display 18 may be protected using a display cover layer such as a layer of transparent glass or clear plastic. Openings may be formed in the display cover layer. For example, an opening may be formed in the display cover layer to accommodate a button such as button 32. An opening may also be formed in the display cover layer to accommodate ports such as speaker port 20-P. Openings may be formed in housing 12 to form communications ports, holes for buttons, and other structures. FIG. 2A further shows how a front-facing camera 22-F may be mounted on a front face of housing 12 (e.g., adjacent to speaker port 20-P or at another desired location) and a rear-facing camera 22-R mounted on a rear face of housing 12.

In the example of FIG. 2B, electronic device 10 is a tablet computer. In electronic device 10 of FIG. 2B, housing 12 has opposing planar front and rear surfaces. Display 18 is mounted on the front surface of housing 12. A button 32 and front-facing camera 22-F may also be mounted on the front surface of housing 12. Rear-facing camera 22-R may be mounted on the rear surface of housing 12.

Electronic device 10 of FIG. 2C has the shape of a laptop computer and has upper housing 12A and lower housing 12B with components such as keyboard 33 and touchpad 31. Device 10 has hinge structures 35 (sometimes referred to as a clutch barrel) to allow upper housing 12A to rotate in directions 36 about rotational axis 34 relative to lower housing 12B. Display 18 is mounted in housing 12A. Upper housing 12A, which may sometimes be referred to as a display housing or lid, is placed in a closed position by rotating upper housing 12A towards lower housing 12B about rotational axis 34. A front-facing camera 22-F may be formed along the upper edge of display 18 or elsewhere on housing 12.

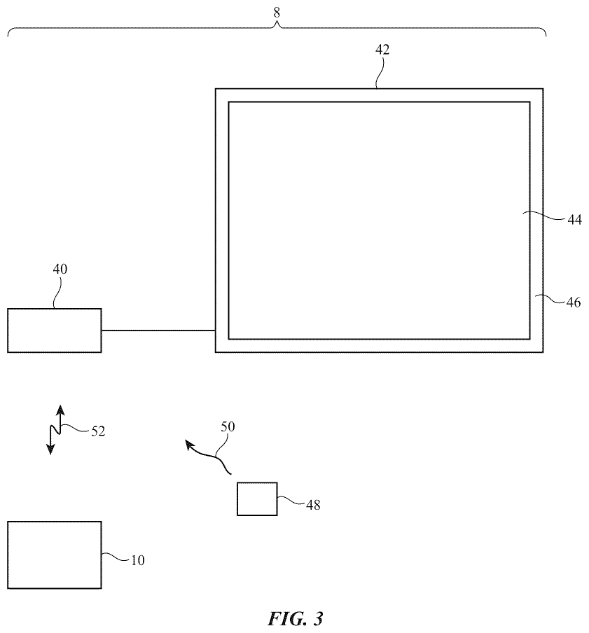

FIG. 3 shows a system 8 of electronic devices including electronic device 10. As shown in FIG. 3, system 8 also includes electronic devices 40, 42, and 48. Electronic devices 10, 40, 42, and 48 may be associated with the same user (e.g., signed into a cloud service using the same user ID), may exchange wireless communications, etc. In general, each one of electronic devices 10, 40, 42, and 48 may be any desired type of electronic device (e.g., cellular telephone, laptop computer, speaker, computer monitor, electronic watch, tablet computer, head-mounted device, remote control, television, etc.). As examples, electronic device 42 may be a television or other device that includes a display. Electronic device 40 may be a source device that supplies images to the electronic device 42. There may be a wired connection (as depicted in FIG. 3) or a wireless connection between devices 40 and 42. Electronic device 40 may have a small console form factor without a display. Electronic device 40 may sometimes be referred to as a set-top box. Electronic device 48 may be a remote control that is configured to transmit signals to electronic device 40 and/or electronic device 42 as shown by transmissions 50. Electronic device 10 may both transmit signals and receive signals as shown by wireless link 52.

Each one of electronic devices 40, 42, and 48 may include any desired input-output components (e.g., similar to the input-output circuitry described in connection with FIG. 1). As shown in FIG. 3, electronic device 42 may include a display 44 coupled to a housing 46. Display 44 may include an organic light-emitting diode display or other displays based on arrays of light-emitting diodes, a liquid crystal display, a liquid-crystal-on-silicon display, a projector or display based on projecting light beams on a surface directly or indirectly through specialized optics (e.g., digital micromirror devices), an electrophoretic display, a plasma display, an electrowetting display, or any other desired display.

Each one of electronic devices 40, 42, and 48 may optionally include communication circuitry (similar to communication circuitry 56 in FIG. 1) to exchange wired and/or wireless communications with other devices in system 8.

During operation of system 8, remote control 48 may sometimes be used to control electronic devices 40 and/or 42. Electronic device 10 may also be used to control electronic devices 40 and/or 42. For example, a user may provide user input to electronic device 10 indicating an intent to control electronic devices 40 and/or 42 using gaze input. Subsequently, electronic device 10 may locate display 44 relative to electronic device 10 (e.g. using rear-facing camera 22-R). Gaze input from the user on electronic device 10 may then be used to target and/or select a user interface element on display 44. For example, the user may gaze at a user interface element on display 44. Ray tracing may be used to determine a point of gaze of the user on display 44 (e.g., using gaze information obtained using front-facing camera 22-F). Information regarding the point of gaze on display 44 is then transmitted by electronic device 10 to electronic devices 40 and/or 42 to control electronic devices 40 and/or 42.

In addition to transmitting point of gaze information to electronic devices 40 and/or 42 to control electronic devices 40 and/or 42, electronic device 10 may transmit gesture information to electronic devices 40 and/or 42 to control electronic devices 40 and/or 42. Gesture information (e.g., information identifying hand gestures and/or head gestures) may be obtained using front-facing camera 22-F.

To avoid conflicting instructions in controlling content presented on display 44, input from remote control 48 may optionally be suppressed when electronic device 10 is used to control electronic devices 40 and/or 42.

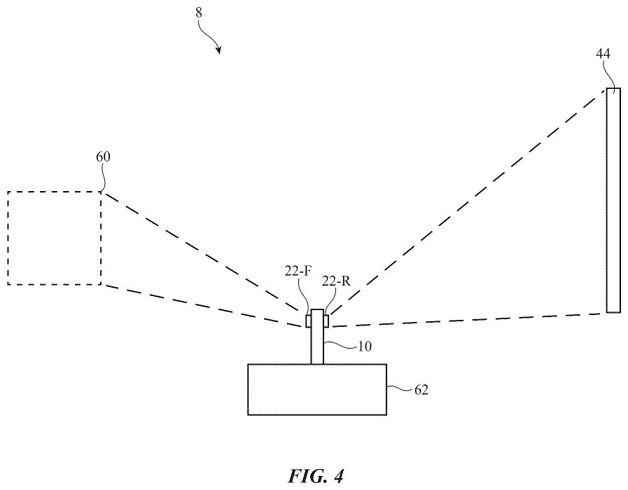

FIG. 4 is side view of system 8 showing how electronic device 10 may obtain gaze input and/or gesture input that is used to control content on display 44. As shown in FIG. 4, electronic device 10 may be placed on a physical object 62 (e.g., a table, floor, desk, etc.) such that rear-facing camera 22-R captures images of display 44 while front-facing camera 22-F simultaneously captures images of user 60.

User 60 may control display 44 using gaze input and/or gesture input identified by electronic device 10. To enable providing gaze input to display 44, electronic device 10 may identify the location of display 44 relative to electronic device 10. Electronic device 10 may identify the location of display 44 relative to electronic device 10 using images captured by one or more cameras in electronic device 10. In the example of FIG. 4, rear-facing camera 22-R captures images of display 44. Electronic device 10 may determine the position of display 44 relative to electronic device 10 using the size, orientation, and/or position of the display within the captured images. Electronic device 10 may optionally receive size information regarding display 44 from devices 40 and/or 42 to provide reference information with which the location of display 44 is determined. Instead or in addition, electronic device 42 may include or display an optical symbol with properties known to electronic device 10 and electronic device 10 may determine the position of display 44 relative to electronic device 10 using the size, orientation, and/or position of the optical symbol within the captured images.

After identifying the location of display 44 relative to electronic device 10, electronic device 10 may use front-facing camera 22-F and ray tracing to determine where on display 44 the user is looking. In this way, the user may provide gaze input to display 44.

The gaze input may be obtained by capturing images of the user using front-facing camera 22-F. Front-facing camera 22-F may determine the location of a user's eyes (e.g., the centers of the user's pupils), may determine the direction in which the user's eyes are oriented (the direction of the user's gaze), may determine the user's pupil size, and/or may be used in monitoring the current focus of the lenses in the user's eyes. After determining a user's gaze vector using front-facing camera 22-F, electronic device may trace the gaze vector until the gaze vector strikes display 44 (using the determined location of display 44). The point at which the gaze vector strikes display 44 is the point on display 44 at which the user is looking. This location may be transmitted from electronic device 10 to display 44 to provide gaze input to display 44 using electronic device 10.

In addition to gaze input, front-facing camera 22-F may be used to obtain gesture input. Front-facing camera 22-F may analyze the captured images of user 60 to identify when user 60 performs a hand gesture, a head gesture, or another desired type of gesture. Examples of hand gestures include a user tapping their thumb and index finger together (sometimes referred to as a pinch gesture), pinching their fingers and moving their hand (sometimes referred to as a pinch-and-drag), pinching their fingers and flicking their wrist, etc. Examples of head gestures include a user nodding their head up and down (e.g., nodding ‘yes’), shaking their head side to side (e.g., shaking their head ‘no’), or moving their head in any direction or combination of directions. The gesture information obtained using electronic device 10 may be transmitted from electronic device 10 to display 44 to provide gesture input to display 44 using electronic device 10.

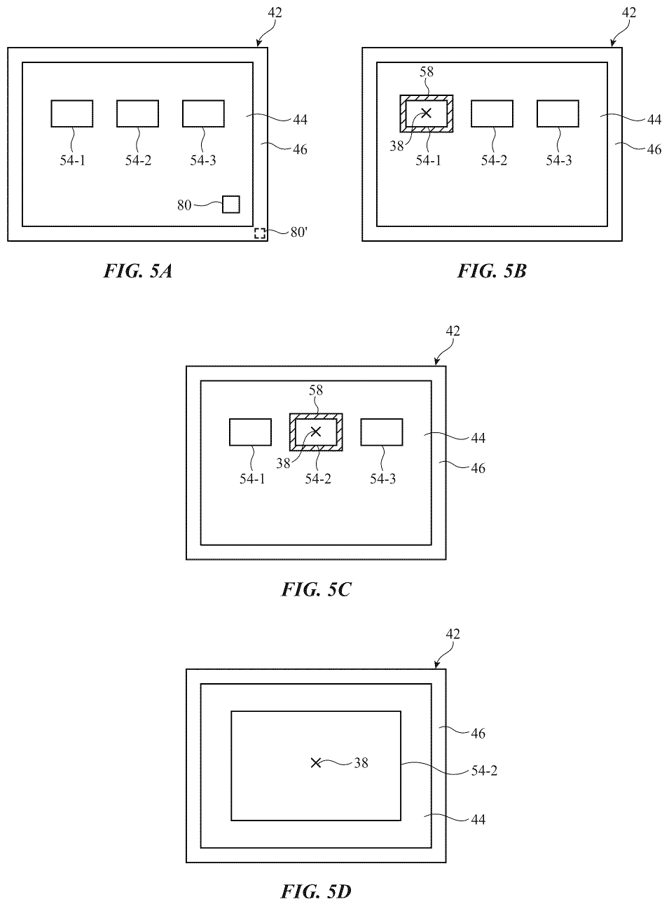

FIGS. 5A-5D are views of an illustrative display showing how electronic device 10 may be used to control content on the display. FIG. 5A shows electronic device 42 after a user has provided user input associated with an intent for interaction with electronic device 42. The user input associated with an intent for interaction with electronic device 42 may be detected by electronic device 10. The user input associated with an intent for interaction with electronic device 42 may include, as examples, gaze input detected by front-facing camera 22-F, touch input to a touch sensor such as a swipe or a press, a press of a button such as button 32, a hand gesture detected by camera 22-F, a head gesture detected by camera 22-F, a voice command detected by microphone 30, etc.

After receiving the user input associated with the intent for interaction with electronic device 42, electronic device 10 may transmit information associated with the user input to electronic device 40 (e.g., in arrangements where electronic device 40 controls the content presented on display 44 of electronic device 42) or directly to electronic device 42 (e.g., in arrangements where electronic device 40 is omitted from the system and electronic device 42 is a standalone device).

Transmitting the information associated with the user input to electronic device 40 and/or electronic device 42 may cause display 44 of electronic device 42 to display an optical symbol 80. The optical symbol may subsequently be used by electronic device 10 to determine the location of display 44 relative to electronic device 10. The optical symbol 80 may be displayed simultaneously with one or more user interface elements such as user interface elements 54-1, 54-2, and 54-3. Optical symbol 80 may be an icon that is associated with establishing gaze control of electronic device 42. Instead or in addition, the optical symbol may include one or more glyphs.

In general, the appearance of optical symbol 80 may be selected to either be conspicuous to the viewer or inconspicuous to the viewer. When the optical symbol is conspicuous to the viewer, the optical symbol is meant to clearly indicate to the user that gaze control of electronic device 42 using electronic device 10 is being established. To make the optical symbol inconspicuous to the viewer, the optical symbol may be integrated into the user interface presented on display 44 (or other content that is being displayed on display 44). As an example, an icon or one or more glyphs that are part of a user interface element presented on display 44 may serve as optical symbol 80. Another option for an optical symbol that is inconspicuous to the viewer is to present the optical symbol using non-visible (e.g., infrared) light that may be detected by electronic device 10 (but will not be seen by the user's eyes).

Camera 22-R in electronic device 10 may capture images of electronic device 42. Electronic device 10 may have knowledge of the size and shape of optical symbol 80. Therefore, when display 44 presents optical symbol 80, electronic device 10 may recognize the optical symbol in images from camera 22-R and use the images from camera 22-R to precisely determine a location of display 44 relative to electronic device 10. The process of determining the location of display 44 relative to electronic device 10 using images captured by electronic device 10 may be referred to as an optical pairing process.

FIG. 5A shows an example where optical symbol 80 is displayed on display 44. This example is merely illustrative. If desired, the optical symbol 80 may instead be visible on a non-display portion of electronic device 42 such as housing 46 (as shown by symbol 80′).

The example of using an optical symbol in the process of determining the location of display 44 relative to electronic device 10 is merely illustrative. If desired, no optical symbol may be used and electronic device 10 may determine the location of display 44 using images of display 44 (and/or information regarding the size and/or shape of display 44).

Once the electronic device has determined the location of display 44 relative to electronic device 10 (e.g., once optical pairing is complete), gaze input obtained using front-facing camera 22-F may be used to determine a point of gaze of the user on display 44. As shown in FIG. 5B, ray tracing may be used to determine that point of gaze 38 overlaps user interface element 54-1. This information may be transmitted from electronic device 10 to electronic device 40 (e.g., in arrangements where electronic device 40 controls the content presented on display 44 of electronic device 42) or directly to electronic device 42 (e.g., in arrangements where electronic device 40 is omitted from the system and electronic device 42 is a standalone device). Electronic device 10 may optionally receive information from electronic devices 40 and/or 42 regarding the size and layout of user interface elements on display 44.

The transmitted information may include coordinate information (e.g., a two-dimensional coordinate with units of distance, a two-dimensional coordinate defined relative to the length and width of the display, a two-dimensional coordinate with units of pixels, etc. that corresponds to a specific position on display 44). Alternatively, electronic device 10 may use the size and layout of user interface elements 54 (received from electronic devices 40 and/or 42) to determine which user interface element 54 is overlapped by the point of gaze. In this case, the transmitted information from electronic device 10 to electronic devices 40 and/or 42 may include a selected user interface element (and not specific coordinate information).

As shown in FIG. 5B, when electronic devices 40 and/or 42 receive information from electronic device indicating that point of gaze 38 overlaps (targets) user interface element 54-1, a visual indicator 58 may be presented on display 44 that identifies user interface element 54-1. The visual indicator 58 may be an outline that highlights user interface element 54-1 as the targeted user interface element out of user interface elements 54-1, 54-2, and 54-3. The visual indicator 58 may be a complete outline around the user interface element (as in FIG. 5B) or a partial outline around the user interface element (e.g., four discrete portions may be presented at each corner of the user interface element). Instead or in addition, the color of the selected user interface element may be changed (e.g., the user interface element may be highlighted), a preview video associated with the user interface element may be played, and/or the size of the selected user interface element may be increased.

As shown in FIG. 5C, if the point of gaze 38 changes to instead overlap a different user interface element such as user interface element 54-2, this information is transmitted to electronic devices 40 and/or 42 and visual indicator 58 is moved to instead highlight the targeted user interface element 54-2.

The user may subsequently provide gesture input to confirm an action associated with the targeted user interface element (e.g., to select or click the targeted user interface element). For example, the user interface element identified by the gaze input may be selected in response to a gesture (e.g., a head gesture or hand gesture) and/or in response to other user input (e.g., gaze input, touch input, a button press, a voice command, etc.). After the user interface element is selected using the gesture or other user input, the content on display 44 may be updated.

FIG. 5D shows an example where a hand gesture is identified by front-facing camera 22-F and information regarding this gesture is transmitted to electronic device 40 and/or 42. In response to receiving the information identifying the hand gesture while point of gaze 38 overlaps user interface element 54-2, user interface element 54-2 may be expanded on display 44 (and user interface elements 54-1 and 54-3 may no longer be displayed). In other words, electronic device 10 detects both the point of gaze 38 overlapping user interface element 54-2 and a hand gesture selecting user interface element 54-2.

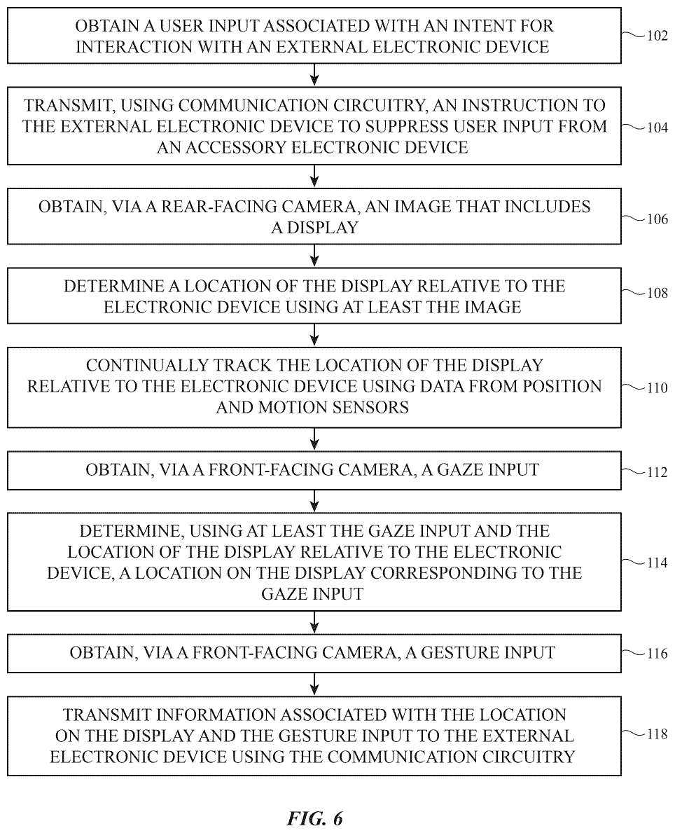

FIG. 6 is a flowchart of an illustrative method for operating an electronic device that controls an external electronic device using gaze input and gesture input. First, at block 102, the electronic device 10 may receive a user input associated with an intent for interaction with the external electronic device. The user input received at block 102 may include a gaze input such as looking in a predetermined corner of display 18 on electronic device 10 (sometimes referred to as a hot corner), a touch input to a touch sensor such as a swipe or a press, a button press to a button such as button 32, a voice command that is detected by microphone 30, a hand gesture that is detected by one of cameras 22, a motion gesture that is detected by position and motion sensors 24, a head gesture that is detected by one of cameras 22, etc.

At block 104, in accordance with obtaining the user input at block 102, electronic device 10 may transmit, using communication circuitry 56, an instruction to the external electronic device to suppress user input from its own input device(s) and/or an accessory electronic device. For example, the electronic device 10 may transmit an instruction to suppress input to the external electronic device that is provided via a remote control (e.g., remote control 48 in FIG. 3). This prevents a situation where both electronic device 10 and remote control 48 simultaneously provide conflicting user input to the external electronic device. In another example, the electronic device 10 may transmit an instruction to suppress input to the external electronic device that is provided via a touch screen of the external electronic device to prevent simultaneous conflicting user input to the external electronic device.

Also at block 104, the electronic device 10 may transmit information to the external electronic device identifying the user input (e.g., identifying the user intent for interaction with the external electronic device). This may cause the external electronic device to display an optical symbol that is later detected by electronic device 10 and/or may cause the external electronic device to transmit display dimension information to electronic device 10.

The example of electronic devices 40 and/or 42 suppressing input from a remote control at block 104 is merely illustrative. In general, electronic devices 40 and/or 42 may suppress input at any of their input devices in response to receiving the information from electronic device 10 at block 104.

At block 106, electronic device 10 may obtain an image that includes a display associated with the external electronic device using one of cameras 22 in electronic device 10. The display may be a display that is part of the external electronic device (e.g., in arrangements where electronic device 40 is omitted and electronic device 42 is a standalone electronic device that communicates directly with electronic device 10). Alternatively, the display may be part of an additional electronic device (e.g., electronic device 42 in FIG. 3) that has a wired connection to electronic device 40. Electronic device 10 may obtain the image of the display using rear-facing camera 22-R. The operations of block 106 may be performed in accordance with obtaining the user input at block 102. In other words, the rear-facing camera may turn on at block 106 or may have a sampling frequency increased at block 106.

At block 108, electronic device 10 may determine a location of the display relative to electronic device 10 using at least the image of the display from block 106. Electronic device 10 may determine the location of display 44 relative to electronic device 10 using a position, size, and/or shape of the display and/or a position, size, and/or shape of an optical symbol associated with display 44.

It is additionally noted that electronic device 10 may use depth sensor 28 to help determine the location of display 44 relative to electronic device 10. The depth sensor may determine the distance between display 44 and electronic device 10, as one example. The operations of block 108 may sometimes be referred to as optical pairing operations.

After determining the location of the display at block 108, the location of the display relative to electronic device 10 may be continuously tracked using data from position and motion sensors 24, cameras 22, and/or depth sensor 28 (e.g., using simultaneous localization and mapping techniques) at block 110. In particular, position and motion sensors may measure changes in position and/or orientation of electronic device 10 and use this information to track the location of display 44 relative to electronic device 10. However, the optical pairing in block 108 may be the most accurate technique to determine the location of display 44 relative to electronic device 10. Therefore, instead of continuously tracking the location of display 44 using position and motion sensors as in block 110, block 108 may alternatively be performed repeatedly to continuously track the location of the external electronic device. In general, the optical pairing of block 108 may be performed at any desired frequency to ensure a real-time location of display 44 relative to electronic device 10 is known. Even if SLAM techniques are used, the optical pairing of block 108 may still be performed intermittently to occasionally obtain a high accuracy location for display 44. The operations of block 108 may be performed more frequently if the location of display 44 relative to head-mounted device 10 is changing rapidly and may be performed less frequently if the location of display 44 is not changing (or hardly changing) relative to head-mounted device 10.

During the operations of block 112, electronic device 10 may obtain a gaze input using at least one camera 22. As an example, electronic device 10 may use front-facing camera 22-F to obtain the gaze input. The gaze input obtained at block 112 may be a gaze direction vector identifying the direction in three-dimensional space the user's eyes are looking.

It is noted that the sensor data obtained at blocks 106, 110, and 112 may only be obtained in response to the detected user input at block 102. In other words, the rear-facing camera 22-R may be turned on (or have a sampling rate increased) at block 106, the position and motion sensors 24 may be turned on (or have a sampling rate increased) at block 110, and the front-facing camera 22-F may be turned on (or have a sampling rate increased) at block 112.

At block 114, electronic device 10 may determine, using at least the input from block 112 (e.g., gaze direction vector) and the location of display 44 relative to electronic device 10 (as determined using at least the image from block 106), a location on the display corresponding to the gaze input. Ray tracing may be performed at block 114 to identify a point of gaze 38 on display 44.

At block 116, electronic device 10 may obtain a gesture input using at least one camera 22. As an example, electronic device 10 may use front-facing camera 22-F to obtain the gesture input. Electronic device 10 may therefore use the same camera to obtain the gaze input (at block 112) and the gesture input (at block 116). Captured images from front-facing camera 22-F may be analyzed to identify both the gaze input and the gesture input.

The gesture input identified at block 116 may include hand gestures (in which user 60 moves their hands in a known gesture), head gestures (in which user 60 moves their head in a known gesture), and/or other desired types of gestures.

At block 118, electronic device 10 may transmit information associated with the location on the display and the gesture input to the external electronic device using the communication circuitry. The information associated with the location on the display transmitted at block 118 may include coordinate information (e.g., a two-dimensional coordinate identifying a position on display 44) or may include a targeted user interface element. For example, electronic device 10 may receive information on the size/layout of user interface elements on display 44 and may therefore directly determine which user interface element is targeted. When electronic device 10 receives information on the size/layout of user interface elements on display 44, the electronic device may optionally generate transparent virtual objects associated with the user interface elements to leverage the electronic device's ability to detect alignment of point of gaze with virtual objects. When electronic device 10 receives information on the size/layout of user interface elements on display 44, electronic device 10 may transmit information identifying a targeted user interface element instead of or in addition to coordinate information.

Blocks 112, 114, 116, and 118 may be performed repeatedly so that the gaze and gesture input is continuously used to provide user input to display 44.

At any time during the method of FIG. 6, the user may provide a user input associated with an intent to no longer interact with the external electronic device. In other words, the user may turn off the gaze and gesture control at any desired time.

The order of operations presented in FIG. 6 is merely illustrative. In general, the operations of FIG. 6 may be performed in any order and multiple operations may be performed at the same time. For example, camera 22-R may capture images at block 106 at the same time as front-facing camera 22-F captures images for detecting gaze input and gesture input at blocks 112 and 116.

Consider an example where electronic device 42 is a television with a wired connection to electronic device 40. Electronic device 40 is a source device that supplies images to the television 42 using the wired connection. Electronic device 48 is a remote control that provides input to source device 40. At a first time, a user may use remote control 48 to provide input to source device 40 and control the content on television 42.

At block 102, electronic device 10 receives a user input associated with an intent for interaction with television 42. The user input may be a voice command detected by microphone 30 of electronic device 10. At block 104, in accordance with receiving the user input at block 102, the electronic device transmits an instruction to source device 40 to suppress user input from remote control 48. This allows electronic device 10 to provide input to source device 40 and control the content on television 42 without input from remote control 48 causing conflicting instructions.

At block 106, electronic device 10 may use rear-facing camera 22-R to capture images of display 44 on television 42. Then, at block 108, electronic device 10 may use the images from block 106 to determine a location of display 44 relative to electronic device 10. Electronic device 10 may determine the location of display 44 relative to electronic device 10 using known dimensions of display 44, using a detected optical symbol associated with display 44, etc.

After determining the location of display 44 relative to electronic device 10 at block 108, electronic device 10 may continually track the location of display 44 relative to electronic device 10 using data from position and motion sensors at block 110.

At block 112, front-facing camera 22-F is used to obtain a gaze input (e.g., a direction of gaze) from a user. The gaze input is subsequently used at block 114 to determine a location on display 44 (e.g., point of gaze 38 in FIGS. 5B-5D) corresponding to the gaze input. At block 116, front-facing camera 22-F is used to obtain a gesture input such as a hand gesture.

At block 118, electronic device 10 transmits coordinate information for the location on display 44 determined at block 114 and information identifying the hand gesture from block 116 to source device 40. Source device 40 may update the content on display 44 based on the information received from electronic device 10 (e.g., source device 40 may select content based on the received information).

Consider another example where electronic device 42 is a standalone computer monitor and source device 40 and remote control 48 are omitted from the system. At block 102, electronic device 10 receives a user input associated with an intent for interaction with computer monitor 42. The user input may be a voice command detected by microphone 30 of electronic device 10. At block 104, in accordance with receiving the user input at block 102, the electronic device transmits an instruction to computer monitor 42 to suppress user input from its input components. This allows electronic device 10 to provide input to computer monitor 42 without other inputs causing conflicting instructions.

At block 106, electronic device 10 may use rear-facing camera 22-R to capture images of display 44 on computer monitor 42. Then, at block 108, electronic device 10 may use the images from block 106 to determine a location of display 44 relative to electronic device 10. Electronic device 10 may determine the location of display 44 relative to electronic device 10 using known dimensions of display 44, using a detected optical symbol associated with display 44, etc.

After determining the location of display 44 relative to electronic device 10 at block 108, electronic device 110 may continually track the location of display 44 relative to electronic device 10 using data from position and motion sensors at block 110.

At block 112, front-facing camera 22-F is used to obtain a gaze input (e.g., a direction of gaze) from a user. The gaze input is subsequently used at block 114 to determine a location on display 44 (e.g., point of gaze 38 in FIGS. 5B-5D) corresponding to the gaze input. At block 116, front-facing camera 22-F is used to obtain a gesture input such as a hand gesture.

At block 118, electronic device 10 transmits coordinate information for the location on display 44 determined at block 114 and information identifying the hand gesture from block 116 to computer monitor 42. Computer monitor 42 may update the content on display 44 based on the information received from electronic device 10 (e.g., computer monitor 42 may select content based on the received information).

In the examples above, front-facing camera 22-F is used to simultaneously detect gaze input and gesture input whereas rear-facing camera 22-R is used to capture images of display 44 (for determining the location of display 44 relative to electronic device 10). This example is merely illustrative. It is noted that a single camera (e.g., front-facing camera 22-F) may be used to capture images of display 44 (for determining the location of display 44 relative to electronic device 10) and then simultaneously detect gaze input and gesture input.

Consider the example of the laptop computer in FIG. 2C with front-facing camera 22-F but no rear-facing camera 22-R. A user may point the front-facing camera 22-F at display 44 such that the laptop computer determines the location of display 44 relative to the laptop computer (e.g., in an optical pairing operation). The user then rotates the laptop such that front-facing camera 22-F is facing the user. Front-facing camera 22-F may no longer capture images of display 44, but position and motion sensors may use SLAM techniques to continually track the location of display 44 relative to the laptop computer. Once front-facing camera 22-F is facing the user, the front-facing camera may simultaneously detect gaze input and gesture input from the user.

The operations of FIG. 6 may allow for a user to easily control a television or other external electronic device using their cellular telephone, tablet computer, or other electronic device and without using a dedicated remote control. As an example, the user may provide input to their cellular telephone indicating a desire to control a television using the cellular telephone. The user may then prop the cellular telephone on a coffee table that is between them and their television such that the rear-facing camera captures images of the television and the front-facing camera simultaneously captures images of the user. The user may then sit at a distance from the cellular telephone and control the television using gaze and gesture inputs. For example, the user may select content on the television using a combination of gaze and gesture inputs (e.g., targeting content with a point of gaze and performing a hand gesture to select the content). The user may fast forward, rewind, pause, play, or scroll content using one or more hand or head gestures. The gaze detection of blocks 112 and 114 may have a high accuracy even when the user is sitting at far distances from the cellular telephone (e.g., greater than 3 feet, greater than 5 feet, greater than 8 feet, greater than 12 feet, etc.), allowing the user flexibility in where they are positioned relative to the cellular telephone.

As described above, one aspect of the present technology is the gathering and use of information such as sensor information. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

The foregoing is merely illustrative and various modifications can be made to the described embodiments. The foregoing embodiments may be implemented individually or in any combination.

What is claimed is:

1. An electronic device comprising:
one or more sensors;
communication circuitry;
one or more processors; and
memory storing instructions configured to be executed by the one or more processors, the instructions for:
obtaining, via a first subset of the one or more sensors, an image,
wherein the image includes a display;
obtaining, via a second subset of the one or more sensors, a gaze input;
determining, using at least the gaze input and the image, a location on the display corresponding to the gaze input;
obtaining, via the second subset of the one or more sensors, a gesture input; and
transmitting information associated with the location on the display and the gesture input to an external electronic device using the communication circuitry.

2. The electronic device defined in claim 1, wherein the electronic device has first and second opposing sides, wherein the first subset of the one or more sensors comprises a first camera on the first side, and wherein the second subset of the one or more sensors comprises a second camera on the second side.

3. The electronic device defined in claim 1, wherein the instructions further comprise instructions for:
after obtaining the image, determining a location of the display relative to the electronic device using the image; and
after determining the location of the display relative to the electronic device using the image, continually tracking the location of the display relative to the electronic device using data from a third subset of the one or more sensors.

4. The electronic device defined in claim 1, wherein the third subset of the one or more sensors comprises a motion sensor.

5. The electronic device defined in claim 1, wherein the instructions further comprise instructions for:
obtaining a user input associated with an intent for interaction with the external electronic device, wherein obtaining the gaze input comprises obtaining the gaze input in response to obtaining the user input associated with the intent for interaction with the external electronic device and wherein obtaining the image comprises obtaining the image in response to obtaining the user input associated with the intent for interaction with the external electronic device; and
in accordance with obtaining the user input associated with the intent for interaction with the external electronic device, transmitting, using the communication circuitry, an instruction to the external electronic device to suppress user input from an accessory electronic device.

6. The electronic device defined in claim 1, wherein the gesture input comprises a hand gesture or a head gesture.

7. The electronic device defined in claim 1, wherein the external electronic device comprises a source device that provides images to a television that comprises the display and wherein the electronic device is a cellular telephone or a tablet computer.

8. A method of operating an electronic device that comprises one or more sensors and communication circuitry, the method comprising:
obtaining, via a first subset of the one or more sensors, an image, wherein the image includes a display;
obtaining, via a second subset of the one or more sensors, a gaze input;
determining, using at least the gaze input and the image, a location on the display corresponding to the gaze input;
obtaining, via the second subset of the one or more sensors, a gesture input; and
transmitting information associated with the location on the display and the gesture input to an external electronic device using the communication circuitry.

9. The method defined in claim 8, wherein the electronic device has first and second opposing sides, wherein the first subset of the one or more sensors comprises a first camera on the first side, and wherein the second subset of the one or more sensors comprises a second camera on the second side.

10. The method defined in claim 8, further comprising:
after obtaining the image, determining a location of the display relative to the electronic device using the image; and
after determining the location of the display relative to the electronic device using the image, continually tracking the location of the display relative to the electronic device using data from a third subset of the one or more sensors.

11. The method defined in claim 8, wherein the third subset of the one or more sensors comprises a motion sensor.

12. The method defined in claim 8, further comprising:
obtaining a user input associated with an intent for interaction with the external electronic device, wherein obtaining the gaze input comprises obtaining the gaze input in response to obtaining the user input associated with the intent for interaction with the external electronic device and wherein obtaining the image comprises obtaining the image in response to obtaining the user input associated with the intent for interaction with the external electronic device; and
in accordance with obtaining the user input associated with the intent for interaction with the external electronic device, transmitting, using the communication circuitry, an instruction to the external electronic device to suppress user input from an accessory electronic device.

13. The method defined in claim 8, wherein the gesture input comprises a hand gesture or a head gesture.

14. The method defined in claim 8, wherein the external electronic device comprises a source device that provides images to a television that comprises the display and wherein the electronic device is a cellular telephone or a tablet computer.

15. A non-transitory computer-readable storage medium storing one or more programs configured to be executed by one or more processors of an electronic device that comprises one or more sensors and communication circuitry, the one or more programs including instructions for:
obtaining, via a first subset of the one or more sensors, an image, wherein the image includes a display;
obtaining, via a second subset of the one or more sensors, a gaze input;
determining, using at least the gaze input and the image, a location on the display corresponding to the gaze input;
obtaining, via the second subset of the one or more sensors, a gesture input; and
transmitting information associated with the location on the display and the gesture input to an external electronic device using the communication circuitry.

16. The non-transitory computer-readable storage medium defined in claim 15, wherein the electronic device has first and second opposing sides, wherein the first subset of the one or more sensors comprises a first camera on the first side, and wherein the second subset of the one or more sensors comprises a second camera on the second side.

17. The non-transitory computer-readable storage medium defined in claim 15, wherein the instructions further comprise instructions for:
after obtaining the image, determining a location of the display relative to the electronic device using the image; and
after determining the location of the display relative to the electronic device using the image, continually tracking the location of the display relative to the electronic device using data from a third subset of the one or more sensors.

18. The non-transitory computer-readable storage medium defined in claim 15, wherein the third subset of the one or more sensors comprises a motion sensor.

19. The non-transitory computer-readable storage medium defined in claim 15, wherein the instructions further comprise instructions for:
obtaining a user input associated with an intent for interaction with the external electronic device, wherein obtaining the gaze input comprises obtaining the gaze input in response to obtaining the user input associated with the intent for interaction with the external electronic device and wherein obtaining the image comprises obtaining the image in response to obtaining the user input associated with the intent for interaction with the external electronic device; and
in accordance with obtaining the user input associated with the intent for interaction with the external electronic device, transmitting, using the communication circuitry, an instruction to the external electronic device to suppress user input from an accessory electronic device.

20. The non-transitory computer-readable storage medium defined in claim 15, wherein the gesture input comprises a hand gesture or a head gesture.

21. The non-transitory computer-readable storage medium defined in claim 15, wherein the external electronic device comprises a source device that provides images to a television that comprises the display and wherein the electronic device is a cellular telephone or a tablet computer.
